(19) United States
(12) Patent Application Publication
(10) Pub. No.: US 2016/0316126 A1
(43) Pub. Date: Oct. 27, 2016

(54) COMPUTER-READABLE RECORDING MEDIUM, IMAGING METHOD, AND IMAGING SYSTEM

(71) Applicant: FUJITSU LIMITED, Kawasaki-shi (JP)

(72) Inventors: Susumu Saga, Minato (JP); Mimiko Hayashi, Shinagawa (JP); SACHIKO MIYAJIMA, Kawasaki (JP); AKIRA MIYAZAKI, Kawasaki (JP); KIYOSHI KAWANO, Kawasaki (JP); KOUICHI HIDAKA, Kawasaki (JP)

(73) Assignee: FUJITSU LIMITED, Kawasaki-shi, Kanagawa (JP)

(21) Appl. No.: 15/166,990

(22) Filed: May 27, 2016

Related U.S. Application Data
(63) Continuation of application No. PCT/JP2013/085275, filed on Dec. 27, 2013.

(51) Int. Cl. H04N 5/235; G06K 9/00; G02B 21/36

(52) U.S. Cl. CPC H04N 5/2353; G02B 21/367; G06K 9/00134; G06K 2209/17

(57) ABSTRACT

An imaging system includes a first detection sensor configured to detect an imaging target area by the imaging system as a detection target and a second detection sensor configured to detect any portion of a path to the imaging target area as a detection target. The imaging system further includes a processor which performs imaging control by using a condition that a time interval when detection is not performed by the second detection sensor is a predetermined time interval or more and detection is performed by the first detection sensor as an acquisition condition for a captured image of the imaging target area.

### CROSS-REFERENCE TO RELATED APPLICATION

This application is a continuation of International Application No. PCT/JP2013/085275, filed on Dec. 27, 2013, the entire contents of which are incorporated herein by reference.

### FIELD

The embodiments discussed herein are related to a computer-readable recording medium, an imaging method, and an imaging system.

### BACKGROUND

As inspection about food, hygiene inspection is performed to inspect contamination of fungi. For example, a sample taken from a portion of food is smeared or poured on a culture medium prepared on a petri dish. Bacteria included in the sample on the petri dish are maintained at an appropriate temperature, and the bacteria are cultured for a predetermined time interval. After that, hygiene inspection is performed by counting the number of bacteria colonies cultured in the petri dish.

As an example of technique of supporting the hygiene inspection, there is disclosed a technique of counting the number of bacteria colonies from an image obtained by imaging the bacteria colonies cultured on the petri dish.

Patent Document 1: Japanese Laid-open Patent Publication No. 2011-239683

Patent Document 2: Japanese Laid-open Patent Publication No. 2013-21960

Patent Document 3: Japanese Laid-open Patent Publication No. 2006-107407

Patent Document 4: Japanese Laid-open Patent Publication No. 2004-185386

Patent Document 5: Japanese Laid-open Patent Publication No. 2004-199542

Patent Document 6: Japanese Laid-open Patent Publication No. 2011-55467

However, in the above-described techniques, load of an imaging operation for the image is increased.

Namely, when the counting of the number of bacteria colonies is intended to be automated, a procedure of imaging the bacteria colonies cultured on the petri dish is provided. For example, the number of samples on which hygiene inspection is to be performed may reach several hundreds per day. When the petri dishes of which the number reaches several hundreds are to be imaged, a procedure of mounting the petri dish at a predetermined imaging position and performing shutter operation is repeated, so that load of the imaging operation for the image is increased.

### SUMMARY

According to an aspect of an embodiment, a computer-readable recording medium stores therein a program that causes a computer to execute a process including: first acquiring an output of a first detection sensor including an imaging target area by an imaging system as a detection target; second acquiring an output of a second detection sensor including any portion of a path to the imaging target area as a detection target; and performing imaging control by using a condition that a time interval when detection is not performed by the second detection sensor is a predetermined time interval or more and detection is performed by the first detection sensor as an acquisition condition for a captured image of the imaging target area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a perspective diagram illustrating an example of an outer appearance configuration of an imaging system according to a first embodiment;

FIG. 2 is a block diagram illustrating a functional configuration of the imaging system according to the first embodiment;

FIG. 3 is a diagram illustrating an arrangement example of a camera;

FIG. 4 is a diagram illustrating an arrangement example of a first detection sensor and a second detection sensor;

FIG. 5 is a diagram illustrating an example of a situation where sensors respond;

FIG. 6 is a diagram illustrating an example of a situation where sensors respond;

FIG. 7 is a diagram illustrating an example of a cross-sectional diagram;

FIG. 8 is a diagram illustrating an example of a cross-sectional diagram;

FIG. 9 is a diagram illustrating an example of a cross-sectional diagram;

FIG. 10 is a flowchart illustrating a procedure of an imaging process according to the first embodiment;

FIG. 11 is a diagram illustrating an example of a method of slanting a petri dish stage;

FIG. 12 is a diagram illustrating an example of a slanting direction of the petri dish stage;

FIG. 13 is a diagram illustrating an example of a slanting direction of the petri dish stage;

FIG. 14 is a diagram illustrating an arrangement example of a plurality of cameras; and

FIG. 15 is a diagram for explaining an example of a computer executing an imaging program according to the first and second embodiments.

### DESCRIPTION OF EMBODIMENTS

Preferred embodiments will be explained with reference to accompanying drawings. In addition, embodiments are not limited to the disclosed technique. In addition, the embodiments may be appropriately combined within a range where contents of processes are not contradictory.

### a First Embodiment

Outer Appearance Configuration

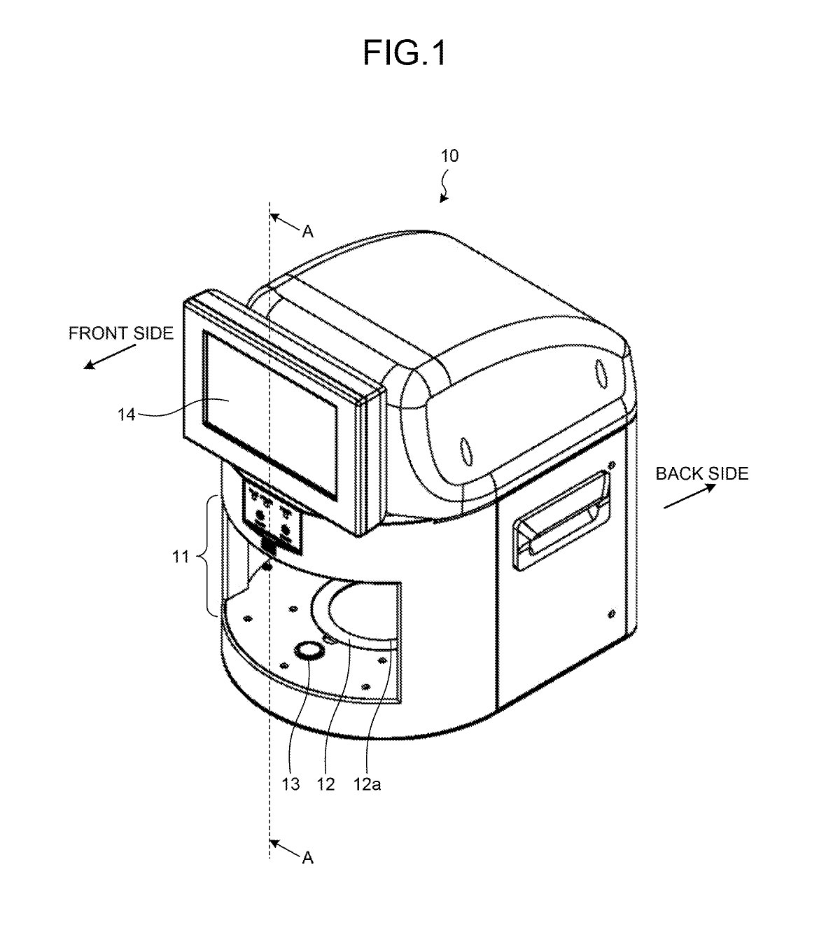

FIG. 1 is a perspective diagram illustrating an example of an outer appearance configuration of an imaging system according to a first embodiment. The imaging system 10 illustrated in FIG. 1 automatically images a petri dish mounted on a petri dish stage 12. In the imaging system 10, a shutter operation during the imaging is automated in order to reduce load of an imaging operation for an image.

As illustrated in FIG. 1, in the imaging system 10, an opening 11 is provided to the front of a housing. An operator can mount the petri dish on the petri dish stage 12 through the opening 11. In this manner, the housing of the imaging system 10 is formed so that the left and right sides, back, and top of the housing excluding the opening 11 of the front cover the petri dish stage 12.

The formation of the housing so as to cover the petri dish stage 12 in this manner is intended to suppress a situation that brightness of the entire image is increased by external light, for example, sunlight, or illumination of a workplace and, thus, a difference in brightness between a portion of the culture medium and it is not possible to detect a portion of the bacteria colony in the petri dish from the after-imaging image.

The petri dish stage 12 is a mount on which the petri dish is mounted. A mount groove 12a which is larger than the outer circumference of the petri dish is formed on the petri dish stage 12 along the outer circumference of the petri dish. In the case where the petri dish is mounted in the mount groove 12a, since the outer circumference portion of the petri dish is engaged with the mount groove 12a, during the imaging, the petri dish can be fixed to the petri dish stage 12. The petri dish stage 12 is formed detachably from the main body of the imaging system 10, and thus, the petri dish stages 12 colored in various colors are used in a replaceable manner. For example, in case of imaging a bacteria colony cultured in a transparent culture medium, a black petri dish stage may be used; and in case of imaging a bacteria colony cultured in a reddish culture medium, a white petri dish stage may be used.

A shutter switch 13 is a switch of changing opening and closing of a shutter of a camera described later. In the imaging system 10 illustrated in FIG. 1, although the automation of the shutter operation is achieved, the shutter switch 13 is installed so as to manually image the petri dish.

A touch panel 14 is a device through which display and input are available. As one aspect thereof, an imaging program executed on a processor included in the imaging system 10 is started, and the touch panel 14 displays an image output by an OS (Operating System) or an application program. As another aspect thereof, the touch panel 14 receives touch manipulation such as tap, flick, sweep, pinch-in, or pinch-out performed on the screen. In addition, herein, although the touch panel 14 is exemplified as an input device of performing instruction input for the imaging system 10, the present invention is not limited thereto, but a physical key or the like for implementing complementary input with respect to the touch panel 14 may be further included.

In addition, the configuration of the imaging system 10 illustrated in FIG. 1 is not limited to the above-described configuration. Namely, the above description does not rule it out that the imaging system 10 has other functional units such as a power button of powering on or off the power of the imaging system or a USB (Universal Serial Bus) port for connecting storage media.

Functional Configuration

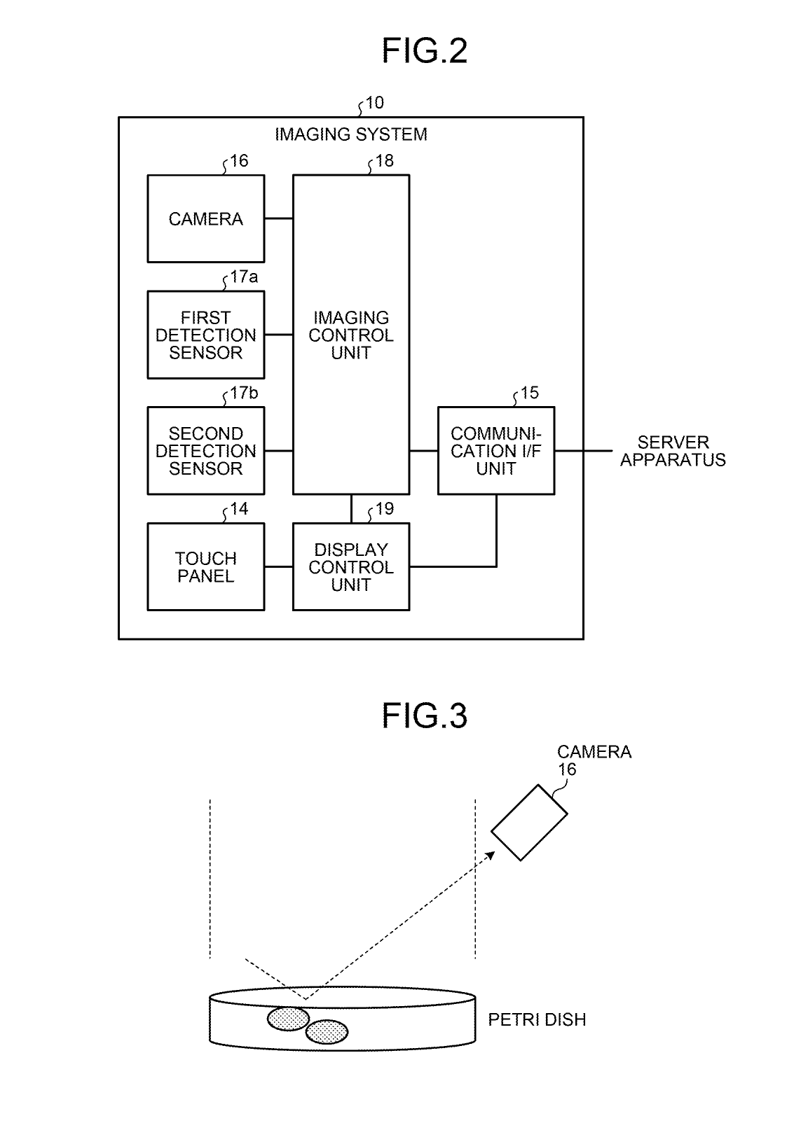

FIG. 2 is a block diagram illustrating a functional configuration of the imaging system 10 according to the first embodiment. As illustrated in FIG. 2, the imaging system 10 is configured to include a touch panel 14, a communication I/F (interface) unit 15, a camera 16, a first detection sensor 17a, a second detection sensor 17b, an imaging control unit 18, and a display control unit 19. In addition, besides the functional units illustrated in FIG. 2, the imaging system may have various functional units used for imaging of a bacteria colony, for example, functional units such as an audio output device of performing audio output.

The communication I/F unit 15 is an interface for control of communication with other apparatuses, for example, a server apparatus (not illustrated). As one aspect of the communication I/F unit 15, a network interface card such as a LAN (Local Area Network) card may be employed. For example, the communication I/F unit 15 transmits a petri dish image obtained by imaging the petri dish mounted on the petri dish stage 12 to the server apparatus or receives a result of counting of the bacteria colonies counted from the petri dish image or the like from the server apparatus.

The camera 16 is an imaging device equipped with an imaging element such as a CCD (Charge Coupled Device) or a CMOS (Complementary Metal Oxide Semiconductor). For example, the camera 16 may be equipped with a plurality of light-receiving elements of R (red), G (green), B (blue), and the like.

FIG. 3 is a diagram illustrating an arrangement example of the camera 16. As illustrated in FIG. 3, the camera 16 is installed to be slanted upward with respect to the petri dish stage 12 on which the petri dish is mounted to allow the petri dish stage 12 to be included within an imaging range. Therefore, this configuration can suppress a situation where the camera 16 is reflected on the culture medium on the petri dish or output light of an illumination device (not illustrated) disposed in an array shape around the camera 16 is directly reflected toward the imaging element of the camera 16. As a result, external disturbance influencing an image process of counting the bacteria colonies may be suppressed. In addition, in the case where the camera 16 images the petri dish from the upward slanted direction, in comparison with the case where the camera 16 is installed just above the petri dish stage 12, accuracy of counting of the bacteria colonies by the image process can be improved. Namely, this is because there is a high possibility that, in case of imaging two bacteria colonies overlapping in the vertical direction, when the imaging is performed just above the petri dish stage 12, one bacteria colony is reflected, and when the imaging is performed from the upward slanted direction of the petri dish stage 12, the two bacteria colonies are separately reflected.

The first detection sensor 17a and the second detection sensor 17b are sensors of detecting approach of an object to a predetermined range. As one aspect of the first detection sensor 17a and the second detection sensor 17b, an infrared sensor or the like may be employed. For example, the first detection sensor 17a and the second detection sensor 17b are configured to set a level of a signal output to the imaging control unit 18 to low in the case where approach of an object is not detected and to set the level of the signal output to the imaging control unit 18 to high in the case where approach of an object is detected.

The first detection sensor 17a includes an imaging target area of the imaging system 10 as a detection target. On the other hand, the second detection sensor 17b includes any portion of a path to the imaging target area as a detection target.

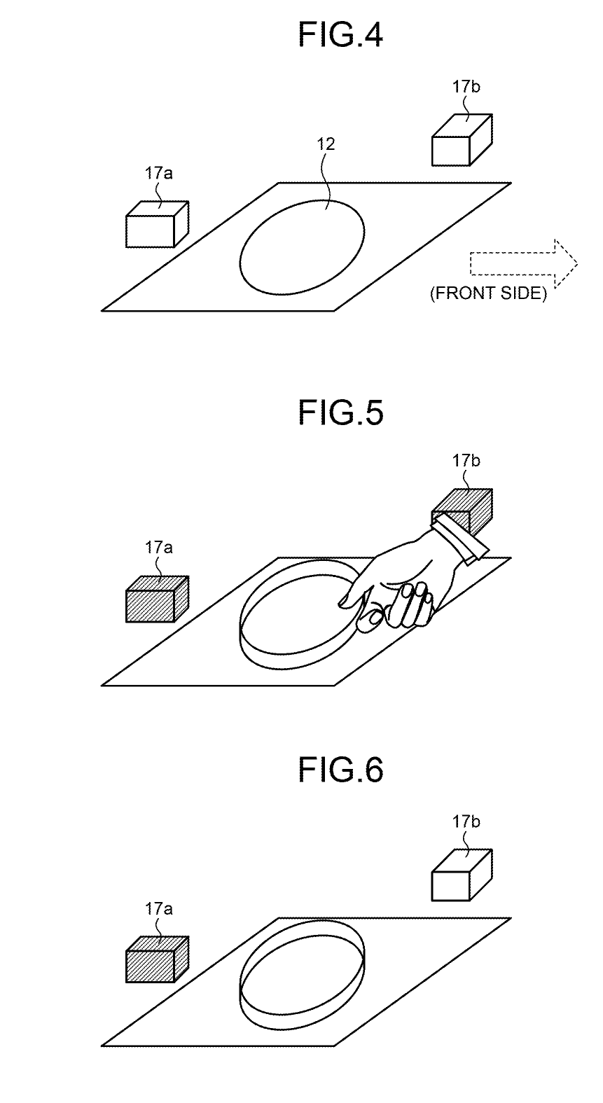

FIG. 4 is a diagram illustrating an arrangement example of the first detection sensor 17a and the second detection sensor 17b. FIGS. 5 and 6 are diagrams illustrating examples of a situation where the sensors respond. In the examples of FIGS. 4 to 6, it is assumed that an operator performing the imaging operation for the petri dish image holds the petri dish with the right hand to mount the petri dish on the petri dish stage 12. In addition, in FIGS. 5 and 6, between the two detection sensors, all the detection sensors responding with the approach of the object are illustrated to be hatched.

As illustrated in FIG. 4, the first detection sensor 17a and the second detection sensor 17b are installed inside a cavity which is disposed inside the opening 11 of the imaging system 10. The first detection sensor 17a is disposed at a position inward from the petri dish stage 12, and the second detection sensor 17b is disposed at the right side from the petri dish stage 12 and is disposed at the front side from the petri dish stage 12. Therefore, the first detection sensor 17a illuminates the hollow space above the petri dish stage 12 from the inner side of the petri dish stage 12 with infrared light. Therefore, in the case where the petri dish is mounted on the petri dish stage 12, the first detection sensor 17a can detect the approach of the petri dish. On the other hand, the second detection sensor 17b illuminates the petri dish stage in the direction from the right side of the petri dish stage 12 to the left side of the petri dish stage 12 with infrared light. In other words, by the operator located in front of the imaging system 10, the second detection sensor 17b allows a portion of the path to the petri dish stage 12 included in the imaging range of the camera 16, that is, the path where the petri dish is mounted to be included in the detection range. Therefore, in the case where the operator mounts the petri dish on the petri dish stage 12 with the hand, the second detection sensor 17b can detect approach of operator's right hand holding the petri dish.

Under this arrangement, in the step where the operator holds the petri dish with the right hand to mount the petri dish on the petri dish stage 12, as illustrated in FIG. 5, the first detection sensor 17a responds with the approach of the petri dish, and the second detection sensor 17b responds with the approach of operator's right hand. In this manner, in the step where the petri dish is mounted, both of the first and second detection sensors 17a and 17b respond. Therefore, it can be detected that the petri dish is mounted on the petri dish stage 12 by the operator. In addition, in the step where operator's right hand is taken out of the opening 11 in the state that the petri dish is mounted on the petri dish stage 12, as illustrated in FIG. 6, since the petri dish is in the approached state, the first detection sensor 17a continues to respond, but since operator's right hand is taken out of the opening 11, the second detection sensor 17b does not respond. Therefore, it can be detected that operator's hand is taken out in the state that the petri dish is mounted on the petri dish stage 12.

In addition, herein, although the example where the second detection sensor 17b detects the approach of operator's right hand by the arrangement illustrated in FIG. 4 is exemplified, the arrangement of the second detection sensor 17b is not limited thereto. For example, the second detection sensor 17b may be installed at the left side of the petri dish stage 12 to detect the approach of operator's left hand, or the second detection sensors 17b may be installed at the left and right sides thereof to detect both approaches of the left and right hands. In addition, as long as the condition that only operator's hand is detected but the petri dish is not detected is satisfied, the second detection sensor 17b may allow an arbitrary point on the path where the petri dish is mounted to be included in the detection range, and the arrangement position is not limited to the illustrated example.

The imaging control unit 18 is a processing unit of performing imaging control by using a condition that the time interval when detection is not performed by the second detection sensor 17b is a predetermined time interval or more and detection is performed by the first detection sensor 17a as an acquisition condition for the captured image of the imaging target area.

As one aspect, the imaging control unit 18 waits for transition from the state that approach of an object is not detected by the first detection sensor 17a to the state that the approach of the object is detected by both of the first and second detection sensors 17a and 17b. Namely, the imaging control unit waits for the state that the petri dish is mounted on the petri dish stage 12 by the operator. In this manner, after the mounting of the petri dish is detected, the imaging control unit 18 monitors whether or not the state is transitioned to the state that only the approach of the object is detected by the first detection sensor 17a and the approach of the object is not detected by the second detection sensor 17b. Namely, the imaging control unit waits for the state that the operator takes the hand with which the petri dish is mounted out of the opening 11. After that, the imaging control unit 18 monitors whether or not the time interval when the approach of the object is detected by only the first detection sensor 17a, in other words, the time interval when the approach of the object is not detected by only the second detection sensor 17b is continuously maintained for a predetermined time interval, for example, for 1 second or for 3 seconds.

Herein, in the case where the time interval when the approach of the object is not detected by only the second detection sensor 17b is continuously maintained for a predetermined time interval, it may be seen that the petri dish is mounted on the petri dish stage 12, the operator takes the hand with which the petri dish is mounted out of the opening 11, and the operator waits for the imaging by the camera 16. In this case, the imaging control unit 18 determines imaging start for the petri dish. On the other hand, in the case where the time interval when the approach of the object is detected by only the first detection sensor 17a is not continuously maintained for a predetermined time interval, it may be seen that, although the petri dish is mounted on the petri dish stage 12, the operator mounts the petri dish at another position or mounts a different petri dish again, and thus, the second detection sensor 17b responds thereto. In this case, the procedure returns to the process of detecting the mounting of the petri dish.

After the imaging start is determined in this manner, the imaging control unit 18 performs a pre-process for the imaging as follows.

For example, the imaging control unit 18 calculates the tilt angle of the camera 16 where the center of the optical axis of the lens of the camera 16 is directed to the center of the petri dish. Therefore, even in the case where petri dishes having various diameters are mounted on the petri dish stage 12 or the petri dish is mounted to be deviated from the forward/backward direction of the petri dish stage 12, the center of the image captured by the camera 16 and the center of the petri dish are allowed to correspond to each other.

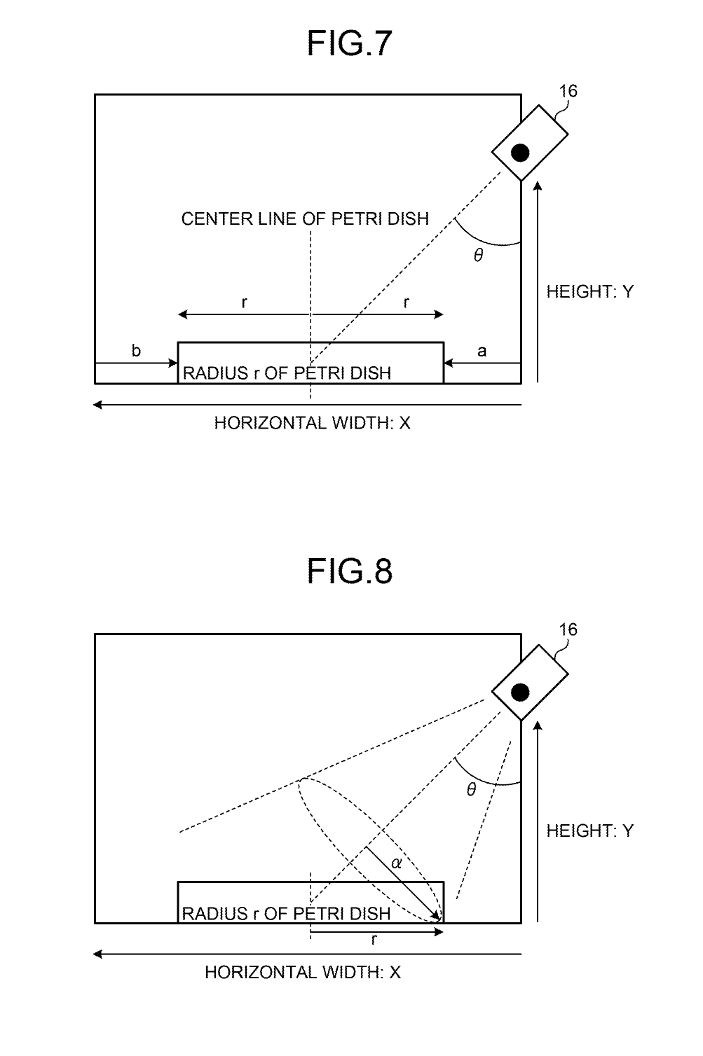

FIG. 7 is a diagram illustrating an example of a cross-sectional diagram. FIG. 7 schematically illustrates a cross-sectional diagram of the imaging system 10 taken along line A-A of FIG. 1. In the example of FIG. 7, the left side of FIG. 7 indicates the opening 11 side, that is, the front side, and the right side of FIG. 7 indicates the back side. The symbol “a” illustrated in FIG. 7 denotes a horizontal distance from the camera 16 to the outer circumference of the inward side of the petri dish, and the symbol “b” denotes a horizontal distance from the opening 11 to the outer circumference of the front side of the petri dish. In addition, the symbol “X” illustrated in FIG. 7 denotes a horizontal width from the opening 11 to the camera 16, and the symbol “Y” denotes a height from the bottom to the camera 16. In addition, the radius r of the petri dish may be variable according to the petri dish mounted on the petri dish stage 12.

As illustrated in FIG. 7, when the tilt angle of the camera 16 where the center of the optical axis of the lens of the camera 16 is directed to the center of the petri dish is denoted by “θ”, Formula (1) “tan θ=(a+r)/Y” may be obtained from the definition of a right-angled triangle. In addition, the horizontal width X may be expressed by Formula (2) “X=a+b+2r”. Formula (2) may be modified as “a+r=X/2+a/2−b/2”. By inserting the modified Formula (2) into the above-described Formula (1), the right-handed side of Formula (1) may be expressed by all known parameters, that is, the horizontal width X, the height Y, the distance “a”, and the distance “b”. Namely, the above-described Formula (1) may be modified as Formula (3) “tan θ=(X/2+a/2−b/2)/Y”. By inserting the distances “a” and “b” measured by a distance sensor (not illustrated) into Formula (3), the value of the right-handed side of Formula (3) may be calculated. The tilt angle θ may be derived from the result of calculation of the right-handed side of Formula (3) obtained in this manner by referring to the trigonometric ratio table of tan θ. After the calculation of the tilt angle, the imaging control unit 18 rotates the camera 16 by the tilt angle θ in vertical direction by using the black point illustrated in FIG. 7 as the start point by controlling a step motor (not illustrated) by using a pulse or the like. After that, the imaging control unit 18 images the petri dish to obtain the petri dish image by performing shutter control.

In addition, the imaging control unit 18 specifies information for extraction of the petri dish used to extract the petri dish portion reflected on the petri dish image by the image process of counting the number of bacteria colonies.

FIG. 8 is a diagram illustrating an example of a cross-sectional diagram. FIG. 8 schematically illustrates a cross-sectional diagram of the imaging system 10 taken along line A-A of FIG. 1. In the example of FIG. 8, the left side of FIG. 8 indicates the opening 11 side, that is, the front side, and the right side of FIG. 8 indicates the back side. The symbol “α” illustrated in FIG. 8 denotes a radius of the range where the petri dish is imaged in the petri dish image. As illustrated in FIG. 8, the radius α may be expressed by the following Formula (4) using sine of “90°−θ” since a right-angled triangle includes the radius α and the radius r of the petri dish. Since the radius r of the petri dish is known by the measurement of the distances “a” and “b”, the radius α may be calculated by modifying Formula (4) into a formula of the radius α. By allowing the radius α together with the petri dish image to be transmitted to the server apparatus, the range where the number of bacteria colonies is counted from the petri dish image may be accurately set.

sin(90°−θ)=α/r (4)

In addition, when the petri dish is mounted on the petri dish stage 12, the imaging control unit 18 allows the camera 16 to image the petri dish from at least two directions. For example, the imaging control unit 18 changes the petri dish imaging angle of the camera 16 by changing the height of the camera 16. Namely, after the imaging control unit 18 images the petri dish by setting the height of the camera 16 to “Y”, the imaging control unit adjusts the height of the camera 16 to Y1 which is smaller than Y. In addition, herein, in case of changing the height of the camera 16, although the case where the value of height is changed into a smaller value is exemplified, the value of the height may be greatly changed. In addition, instead of changing the height of the camera 16, the camera 16 may be allowed to be moved in the horizontal direction.

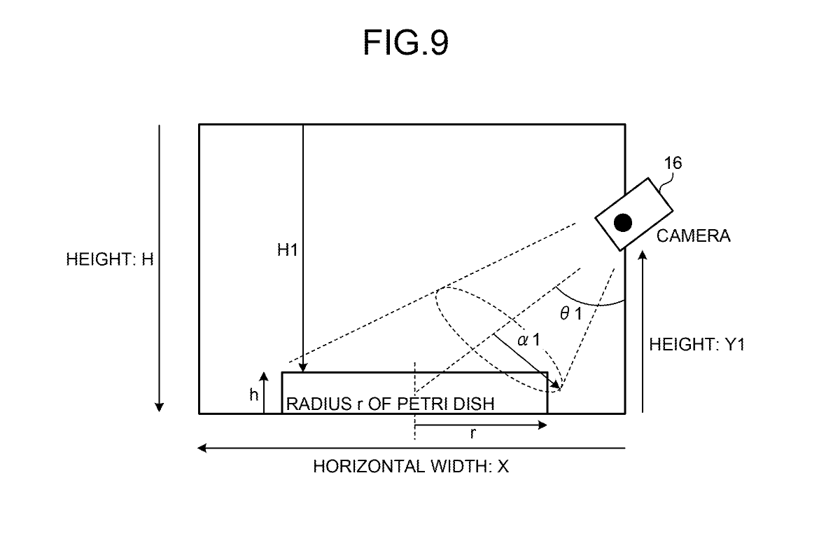

FIG. 9 is a diagram illustrating an example of a cross-sectional diagram. FIG. 9 schematically illustrates a cross-sectional diagram of the imaging system 10 taken along line A-A of FIG. 1. In the example of FIG. 9, the left side of FIG. 9 indicates the opening 11 side, that is, the front side, and the right side of FIG. 9 indicates the back side. Similarly to the symbol “α” illustrated in FIG. 8, the symbol “α1” illustrated in FIG. 9 indicates a radius of a range where the petri dish is reflected on the petri dish image. However, unlike the example of FIG. 8, the symbol indicates the radius of the case where the height of the camera 16 is Y1 and the tilt angle of the camera 16 is θ1. As illustrated in FIG. 9, the radius α1 may be expressed by the following Formula (4) using sine of “90°−θ1” since a right-angled triangle includes the radius α1 and the radius r of the petri dish. Since the radius r of the petri dish is known by the measurement of the distances “a” and “b”, the radius α1 may be calculated by modifying Formula (4) into a formula of the radius α1. In addition, the above-described height Y1 may be set as an arbitrary height from the height h (=H−H1) of the petri dish if the height is within a range h<Y1<H.

In this manner, after the imaging control unit 18 changes the height of the camera 16 into Y1, the imaging control unit repeatedly performs the calculation of the tilt angle θ1 of the camera 16, the adjustment to the tilt angle θ1, and the calculation of the radius α1 used to extract the petri dish portion from the petri dish image and, after that, the imaging control unit performs shutter control. Therefore, the petri dish image captured at the angle different from that of the petri dish image captured at the height Y may be obtained. In addition, the imaging control unit 18 may perform imaging by repeatedly changing the height of the camera 16 a predetermined number of times, that is, an arbitrary number of two or more times.

According to the above-described imaging control, with respect to one petri dish, a plurality of petri dish images captured from a plurality of different directions can be obtained. Therefore, for example, even in the case where a plurality of bacteria colonies overlap the petri dish in the vertical direction, there is a high probability that the petri dish image where the bacteria colonies thereof are separately reflected is included in the plurality of petri dish images. Therefore, it may be possible to improve accuracy of counting the number of bacteria colonies by the image process.

After the imaging of the petri dish is finished, the imaging control unit 18 transmits the plurality of petri dish images and information for extraction of the petri dish for the respective petri dish images, for example, the above-described radius α or radius α1 in association with sample numbers of the petri dish on which the imaging is performed to the server apparatus (not illustrated) through the communication I/F unit 15. Therefore, the server apparatus performs the image process of counting the number of bacteria colonies from the petri dish images transmitted from the imaging system 10.

In addition, the example of the control unit corresponds to the imaging control unit 18 illustrated in FIG. 2.

The display control unit 19 is a processing unit which performs display control on the touch panel 14. As one aspect thereof, the display control unit 19 displays a schedule of imaging the petri dish, displays the sample number of the petri dish which is to be next mounted on the petri dish stage 12, or displays the result of the counting of the number of bacteria colonies received from the server apparatus together with the petri dish image on the touch panel 14.

In addition, the imaging control unit 18 and the display control unit 19 may be embodied by allowing a CPU (Central Processing Unit), an MPU (Micro Processing Unit) or the like to execute the above-described imaging program. In addition, the above-described functional units may be embodied by a hard-wired logic such as an ASIC (Application Specific Integrated Circuit) or an FPGA (Field Programmable Gate Array).

In addition, as a memory used in the above-described imaging control unit 18 and the above-described display control unit 19, a semiconductor memory device or a storage device may be employed. For example, as an example of the semiconductor memory device, there is a flash memory, a DRAM (Dynamic Random Access Memory), an SRAM (Static Random Access Memory), or the like. In addition, as an example of the storage device, there is a storage device such as a hard disk or an optical disk.

Procedure of Process

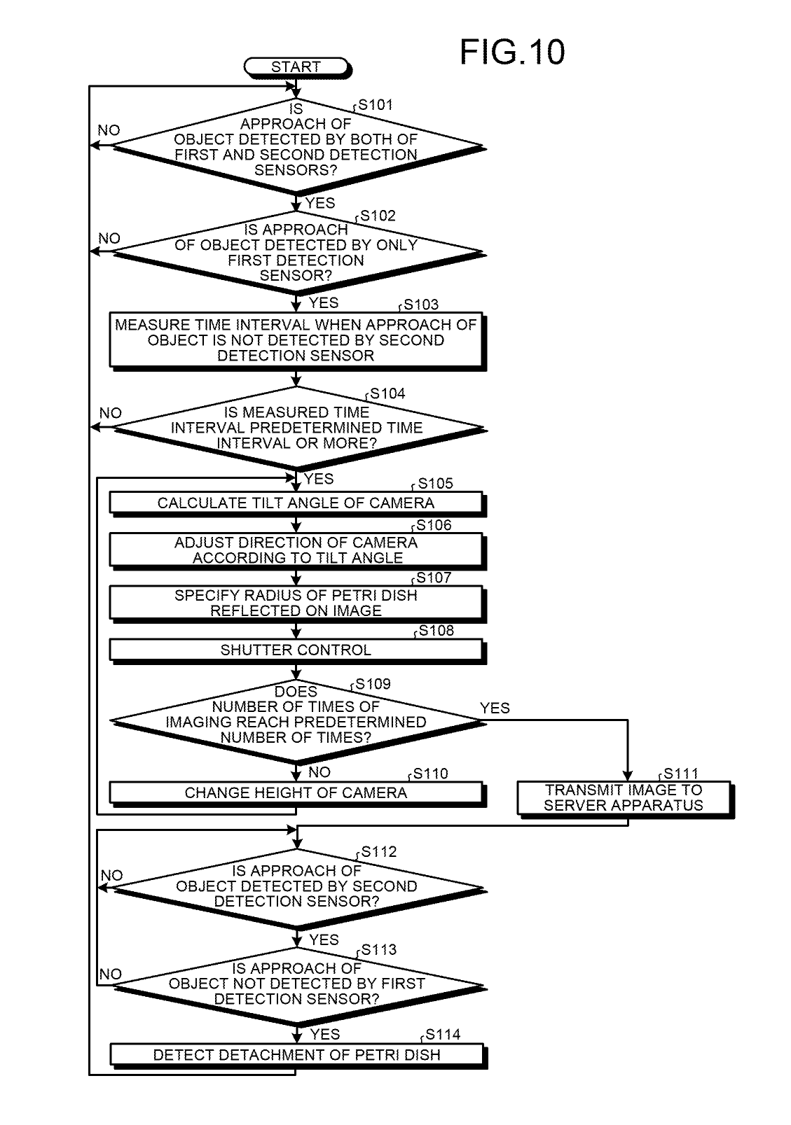

FIG. 10 is a flowchart illustrating a procedure of an imaging process according to the first embodiment. The process is performed in the state that the imaging system 10 is powered on. For example, in the case where an imaging mode of imaging the petri dish is selected among a plurality of modes on the touch panel 14, the imaging is repeatedly performed until the imaging of the petri dish corresponding to the scheduled sample number is finished.

As illustrated in FIG. 10, the imaging control unit 18 monitors transition to the state that the approach of the object is detected by both of the first detection sensor 17a and the second detection sensor 17b (step S101). Namely, in step S101, the imaging control unit monitors that the petri dish is mounted on the petri dish stage 12 by the operator.

If the approach of the object is detected by both of the first detection sensor 17a and the second detection sensor 17b (Yes in step S101), the imaging control unit 18 further monitors transition to the state that the approach of the object is detected by the first detection sensor 17a and the approach of the object is not detected by the second detection sensor 17b (step S102). Namely, in step S102, the imaging control unit waits for the state that the operator takes the hand with which the petri dish is mounted out of the opening 11.

Subsequently, if the approach of the object is detected by only the first detection sensor 17a (Yes in step S102), the imaging control unit 18 measures the time interval when the approach of the object is detected by only the first detection sensor 17a, in other words, the time interval when the approach of the object is not detected by only the second detection sensor 17b (step S103). After that, the imaging control unit 18 determines whether or not the time interval measured in step S103 is a predetermined time interval or more (step S104). In addition, in the case where the approach of the object is not detected by only the first detection sensor 17a in step S102, the procedure returns to the above-described process of step S101.

At this time, in the case where the time interval when the approach of the object is detected by only the first detection sensor 17a is not continuously maintained for a predetermined time interval (No in step S104), it may be seen that, although the petri dish is mounted on the petri dish stage 12, the operator mounts the petri dish at another position or mounts a different petri dish again, and thus, the second detection sensor 17b responds thereto. In this case, the procedure returns to the above-described process of step S101.

In the case where the time interval measured in step S103 is the predetermined time interval or more (Yes in step S104), it may be seen that the petri dish is mounted on the petri dish stage 12, the operator takes the hand with which the petri dish is mounted out of the opening 11, and the operator waits for the imaging by the camera 16.

In this case, the imaging control unit 18 determines imaging start for the petri dish, and the following processes of steps S105 to S108 are performed.

Namely, the imaging control unit 18 calculates the tilt angle of the camera 16 where the center of the optical axis of the lens of the camera 16 is directed to the center of the petri dish by using the distances “a” and “b” measured by a distance sensor (not illustrated) (step S105). Next, the imaging control unit 18 adjusts the orientation of the vertical direction of the camera 16 with the tilt angle θ by controlling a step motor (not illustrated) with a pulse or the like (step S106).

Subsequently, the imaging control unit 18 specifies information for extraction of the petri dish used to extract the petri dish portion reflected on the petri dish image by the image process of counting the number of bacteria colonies (step S107). After that, the imaging control unit 18 captures the petri dish image by allowing the camera 16 to perform shutter control (step S108).

At this time, in the case where the number of times of imaging of one petri dish does not reach a predetermined number of times (No in step S109), the imaging control unit 18 changes the height of the camera 16 (step S110) and repeatedly performs the above-described processes of steps S105 to S108.

On the other hand, in the case where the number of times of imaging of one petri dish reaches a predetermined number of times (Yes in step S109), the imaging control unit 18 transmits the information for extraction of the petri dish specified in step S107 together with the petri dish image captured in step S108 to the server apparatus (step S111).

After that, the imaging control unit 18 monitors whether or not the approach of the object is detected by the second detection sensor 17b (step S112). At this time, if the approach of the object is detected by the second detection sensor 17b (Yes in step S112), the imaging control unit 18 monitors transition to the state that the approach of the object is detected by the first detection sensor 17a (step S113). In addition, until the approach of the object is detected by the second detection sensor 17b (No in step S112), the imaging control unit continues to monitor the output of the second detection sensor 17b (step S112).

Next, in the case where the approach of the object is not detected by the first detection sensor 17a (Yes in step S113), it is detected that the petri dish is detached from the petri dish stage 12 (step S114), and the procedure returns to the above-described step S101.

### Effect of First Embodiment

As described above, the imaging system 10 according to the embodiment allows the camera 16 to image the petri dish under the condition that the time interval when detection is not obtained by the sensor of detecting operator's hand is continuously maintained for a predetermined time interval and detect is obtained by the sensor of detecting the petri dish. Therefore, in the imaging system 10 according to the embodiment, it may be possible to automate the shutter operation. Therefore, according to the imaging system 10 according to the embodiment, it may be possible to reduce load of the imaging operation for the image.

### Second Embodiment

Although the embodiment of the device disclosed heretofore is described, the present invention may be embodied in various different forms besides the above-described embodiment. Therefore, hereinafter, other embodiments of the present invention will be described.

Slant of Stage

In the above-described first embodiment, although the case where a plurality of petri dish images are captured by changing the height of the camera 16 is exemplified, a plurality of petri dish images may also be captured according to other methods. For example, the imaging system 10 may image an imaging object from at least two different directions by controlling driving of a mechanism of changing an arrangement of the imaging object. Although the camera 16 is fixed, a plurality of the petri dish images for one petri dish may be obtained.

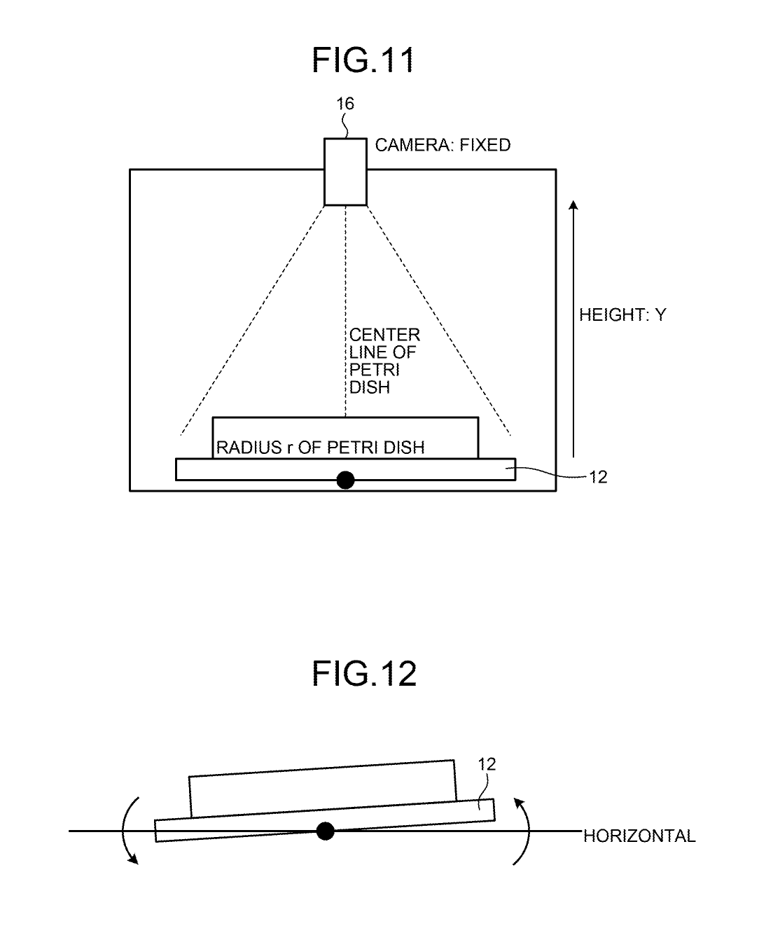

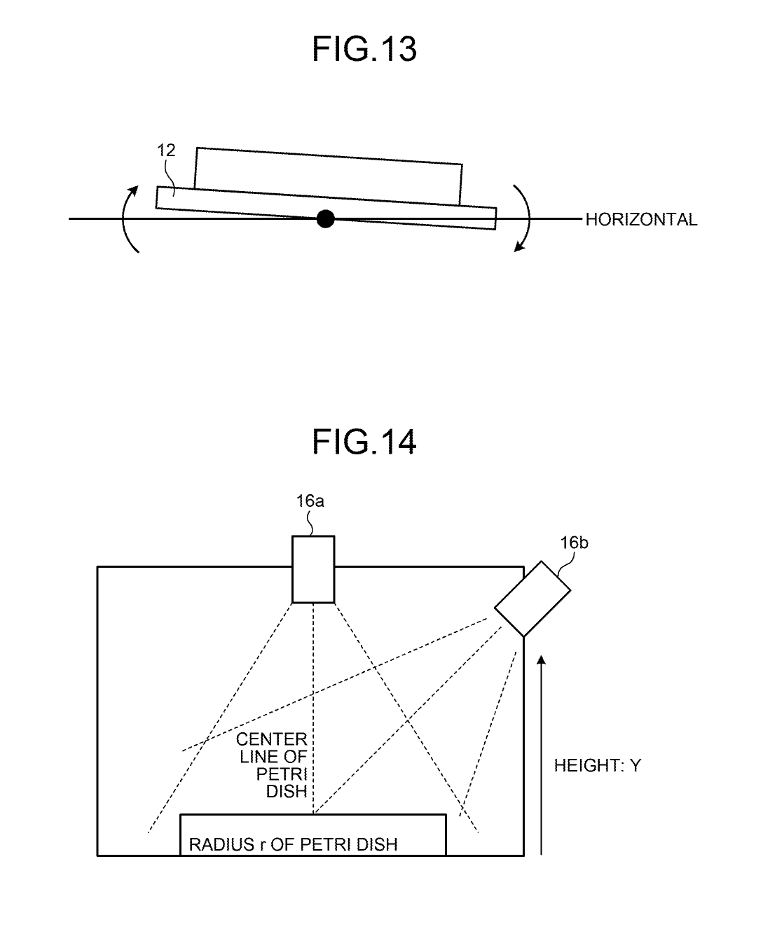

FIG. 11 is a diagram illustrating an example of a method of slanting a petri dish stage 12. FIGS. 12 and 13 are diagrams illustrating examples of a slanting direction of the petri dish stage 12. FIG. 11 schematically illustrates a cross-sectional diagram of the imaging system 10 taken along line A-A of FIG. 1. In the example of FIG. 11, the left side of FIG. 11 indicates the opening 11 side, that is, the front side, and the right side of FIG. 11 indicates the back side. As illustrated in FIG. 11, the imaging system 10 slants the petri dish stage 12 by using the black point of FIG. 11 as a fulcrum. For example, as illustrated in FIG. 12, the half surface of the petri dish stage 12 closer to the front of the imaging system 10 may be slanted downward, and the half surface of the petri dish stage 12 closer to the inward side of the imaging system 10 may be slanted upward. In addition, as illustrated in FIG. 13, the half surface of the petri dish stage 12 closer to the front of the imaging system 10 may be slanted upward, and the half surface of the petri dish stage 12 closer to the inward side of the imaging system 10 may be slanted downward. Therefore, although the camera 16 is fixed, a plurality of the petri dish images for one petri dish may be obtained.

Installation of Cameras

In the above-described first embodiment, although the case where a plurality of petri dish images is captured by using one camera is exemplified, a plurality of petri dish images may also be captured by using a plurality of cameras. In this manner, in case of using a plurality of cameras, control of driving the camera 16 may be omitted, so that it may be possible to reduce an imaging time.

FIG. 14 is a diagram illustrating an arrangement example of a plurality of cameras. FIG. 14 schematically illustrates a cross-sectional diagram of the imaging system 10 taken along line A-A of FIG. 1. In the example of FIG. 14, the left side of FIG. 14 indicates the opening 11 side, that is, the front side, and the right side of FIG. 14 indicates the back side. In the example illustrated in FIG. 14, a camera 16a is installed in the upward direction of the petri dish stage 12, and a camera 16b is installed to be slanted upward with respect to the petri dish stage 12. The camera 16a and the camera 16b are installed to be fixed so that the center of the optical axis of the lens of each camera 16 is directed to the center of the petri dish. By arranging the camera 16a and the camera 16b in this manner, in the step where the petri dish is mounted on the petri dish stage 12, the camera 16a and the camera 16b can simultaneously capture the petri dish image. Therefore, it may be possible to reduce an imaging time for the petri dish image.

Disintegration and Integration

In addition, the components of the devices illustrated are not necessarily configured physically in the same manner as illustrated. Namely, a specific form of disintegration and integration of the devices is not limited to the illustrated from, but all or a portion thereof may be configured by functionally or physically disintegrating and integrating the devices in an arbitrary unit. For example, in the above-described first embodiment, although the case where the image process of counting the number of bacteria colonies from the petri dish image is performed by the server apparatus is exemplified, the image process may be performed by the imaging system 10. In this case, the imaging system 10 may perform counting the number of bacteria colonies in a stand-alone.

Imaging Program

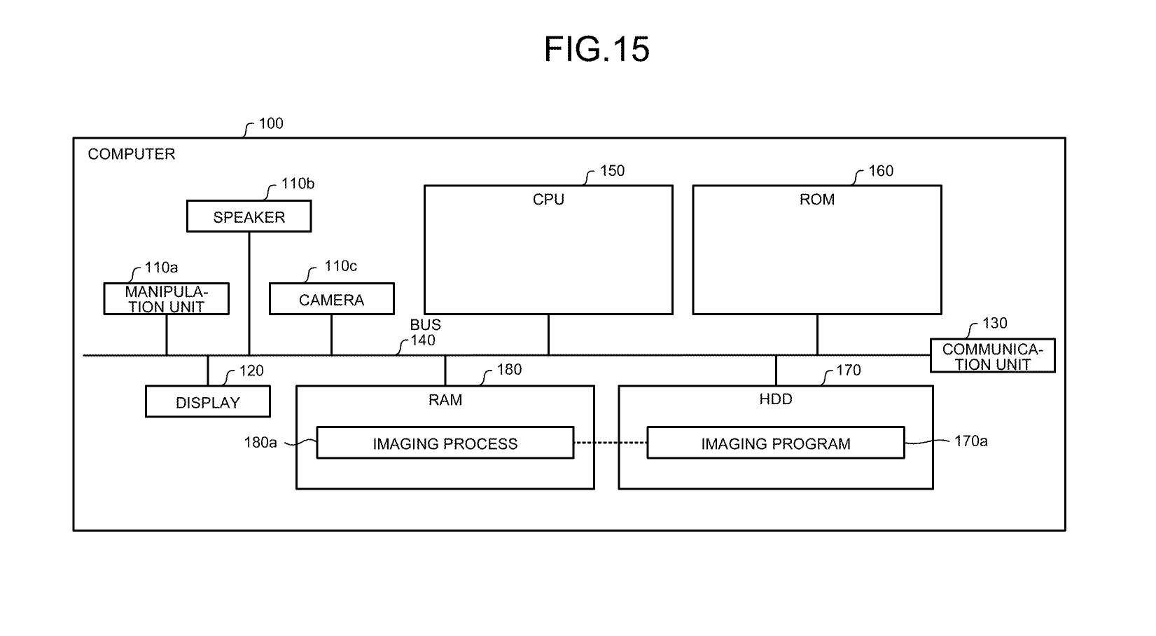

In addition, various processes described in the above-described embodiment may be embodied by causing a computer such as a personal computer or a workstation to execute programs which are prepared in advance. Therefore, hereinafter, an example of a computer of executing an imaging program with the same functions as those of the above-described embodiment will be described with reference to FIG. 15.

FIG. 15 is a diagram for explaining an example of a computer executing an imaging program according to the first and second embodiments. As illustrated in FIG. 15, a computer 100 is configured to include a manipulation unit 110a, a speaker 110b, a camera 110c, a display 120, and a communication unit 130. In addition, the computer 100 is configured to include a CPU 150, a ROM 160, an HDD 170, and a RAM 180. These components 110 to 180 are connected via a bus 140.

As illustrated in FIG. 15, the HDD 170 stores an imaging program 170a in advance, and the imaging program has the same function as the imaging control unit 18 in the above-described first embodiment. With respect to the imaging program 170a, appropriate integration and separation may also be available similarly to the components of the imaging system 10 illustrated in FIG. 2. Namely, with respect to the data stored in the HDD 170, there is no need that all the data are not always stored in the HDD 170, but only the data used for the process may be stored in the HDD 170.

The CPU 150 reads the imaging program 170a from the HDD 170 and develops the imaging program on the RAM 180. Therefore, as illustrated in FIG. 15, the imaging program 170a functions as an imaging process 180a. The imaging process 180a appropriately develops various data read from the HDD 170 on an area of the RAM 180 which can be allocated by itself and executes various processes based on the developed various data. In addition, the imaging process 180a includes the processes performed in the imaging control unit 18 illustrated in FIG. 2, for example, the processes illustrated in FIG. 10. In addition, with respect to the processing units virtually embodied on the CPU 150, there is no need that all the processing units are always operated on the CPU 150, only the processing units used for the processes may be virtually embodied.

In addition, in the above-described imaging program 170a, there is no need that the imaging program is stored in the HDD 170 and the ROM 160 from the initial time. For example, programs may be stored in a “portable physical medium” such as a flexible disk, so-called FD inserted into the computer 100, a CD-ROM, a DVD disk, an opto-magnetic disk, or an IC card. In addition, the computer 100 may acquire the programs from the portable physical medium to execute the programs. In addition, the programs may be stored in other computers or server apparatus connected to the computer 100 through a public line, the Internet, a LAN, a WAN, or the like, and the computer 100 may acquire the programs from the computers or the server apparatus to execute the programs.

The load of the imaging operation for the image can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium having stored therein a program that causes a computer to execute a process comprising:
first acquiring an output of a first detection sensor including an imaging target area by an imaging system as a detection target;
second acquiring an output of a second detection sensor including any portion of a path to the imaging target area as a detection target; and
performing imaging control by using a condition that a time interval when detection is not performed by the second detection sensor is a predetermined time interval or more and detection is performed by the first detection sensor as an acquisition condition for a captured image of the imaging target area.

2. The computer-readable recording medium according to claim 1, wherein the imaging control includes control of imaging an imaging target from at least two different directions.

3. The computer-readable recording medium according to claim 2, wherein the imaging control is performed to image the imaging target from at least two different directions by changing a height of a camera included in the imaging system.

4. The computer-readable recording medium according to claim 1, wherein the imaging control includes control of imaging the imaging target from at least two different directions by control of driving a mechanism of changing an arrangement of the imaging target.

5. The computer-readable recording medium according to claim 1, wherein the process further comprises:
specifying information for extraction of a partial area including the imaging target in the captured image; and
transmitting the specified information to a predetermined destination.

6. An imaging method comprising:
first acquiring, by a processor, an output of a first detection sensor including an imaging target area by an imaging system as a detection target;
second acquiring, by the processor, an output of a second detection sensor including any portion of a path to the imaging target area as a detection target; and
performing, by the processor, imaging control by using a condition that a time interval when detection is not performed by the second detection sensor is a predetermined time interval or more and detection is performed by the first detection sensor as an acquisition condition for a captured image of the imaging target area.

7. An imaging system comprising:
a first detection sensor configured to detect an imaging target area by the imaging system as a detection target;
a second detection sensor configured to detect any portion of a path to the imaging target area as a detection target; and
a processor which performs imaging control by using a condition that a time interval when detection is not performed by the second detection sensor is a predetermined time interval or more and detection is performed by the first detection sensor as an acquisition condition for a captured image of the imaging target area.
